(19) United States
(12) Patent Application Publication
(10) Pub. No.: US 2025/0029080 A1
(43) Pub. Date: Jan. 23, 2025

(54) DECENTRALIZED METADATA REGISTRY

(71) Applicant: Adobe Inc., San Jose, CA (US)

(72) Inventors: David Brian Humpherys, Lehi, UT (US); Jonathan Lancar, Redwood City, CA (US); William Brandon George, Pleasant Grove, UT (US)

(73) Assignee: Adobe Inc., San Jose, CA (US)

(21) Appl. No.: 18/223,197

(22) Filed: Jul. 18, 2023

(51) Int. Cl. G06Q 20/12; H04L 67/1097

(52) U.S. Cl. CPC G06Q 20/1235; H04L 67/1097; G06Q 2220/00

(57) ABSTRACT

Decentralized metadata registry techniques are described. In one or more examples, registration data is received from an originating device at a metadata registry system. The registration data identifies a nonfungible token (NFT), metadata describing one or more characteristics associated with entities that receive the nonfungible token, and access rules to control access to the metadata. The nonfungible token, the metadata, and the access rules are registered as part of a metadata registry. An access request is then received from an originating device. The access request identifies the nonfungible token and requests access to metadata associated with the nonfungible token. A determination is made by the metadata registry system that access to the metadata is permitted based on the access rule and access to the metadata by the originating device is permitted.

### BACKGROUND

Data sharing between service provider systems is confronted with a variety of technical challenges caused by an amount of data being shared, nature of the data, and how the data is managed by respective service provider systems. A service provider system, for example, may maintain data across a multitude of siloed information systems using proprietary techniques to represent “what” is described by the data and relationships of that data to each other.

Conventional intermediary techniques that have been designed to assist in data sharing, as a result, often introduce errors and uncertainty when confronted with these challenges, especially for instances dependent on system-of-record levels of accuracy. Further, conventional techniques often fail to keep the data current due to these technical challenges, thereby resulting in “stale” data that fails in support of its intended purpose. Consequently, conventional data sharing techniques result in inaccuracies, are computationally inefficient, and result in increased power consumption to implement.

### SUMMARY

Decentralized metadata registry techniques are described. These techniques are configurable to leverage a blockchain network and cryptographic tokens (e.g., fungible and nonfungible tokens) to assist data sharing between entities, e.g., client devices, service provider systems, and so forth. In one or more examples, registration data is received from an originating device at a metadata registry system. The registration data identifies a nonfungible token (NFT), metadata describing one or more characteristics associated with entities that receive the nonfungible token, and access rules to control access to the metadata. The nonfungible token, the metadata, and the access rules are registered as part of a metadata registry. An access request is then received from an originating device. The access request identifies the nonfungible token and requests access to metadata associated with the nonfungible token. A determination is made by the metadata registry system that access to the metadata is permitted based on the access rule and access to the metadata by the originating device is permitted.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a decentralized metadata registry environment in an example implementation that is operable to employ techniques described herein.

FIG. 2 is an illustration of a system in an example implementation showing operation of a blockchain network and a service provider system of FIG. 1 in greater detail as minting a nonfungible token.

FIG. 3 depicts a system in an example implementation of dissemination of a nonfungible token to a client device and registration of the nonfungible token as part of a metadata registry.

FIG. 4 depicts a system in an example implementation of access to metadata associated with a nonfungible token as part of a metadata registry.

FIG. 5 is a flow diagram depicting a procedure in an example implementation of registration of a nonfungible token and metadata as part of a metadata registry and access control to the metadata based on an access rule.

FIG. 6 depicts a system in an example implementation in which an access request to a metadata registry is configured as a search query to search metadata to locate a corresponding nonfungible token.

FIG. 7 depicts a system in an example implementation in which event data is located based on a nonfungible token identifier received as part of a search result of FIG. 6.

FIG. 8 depicts a system in an example implementation in which event data is located by a metadata registry system based on a nonfungible token identifier received as part of a search result of FIG. 6.

FIG. 9 is a flow diagram depicting a procedure in an example implementation of a search performed using metadata in a metadata registry to locate a nonfungible token and event data corresponding to the nonfungible token.

FIG. 10 illustrates an example system including various components of an example device that can be implemented as any type of computing device as described and/or utilize with reference to the previous figures to implement embodiments of the techniques described herein.

### DETAILED DESCRIPTION

### Overview

Data sharing between service provider systems, client devices, and other entities is confronted by a variety of technical challenges. Examples of these challenges include an amount of data to be maintained and shared, how to control access to the data, proprietary techniques often encountered in the real world that are used to manage data storage, and so forth. Often, these challenges result in data inaccuracies and “stale” data that is no longer suitable for its intended purpose.

Accordingly, decentralized metadata registry techniques are described. In one or more examples, these techniques are configured to leverage a blockchain network and cryptographic tokens to assist data sharing between entities, e.g., client devices, service provider systems, and so forth. By doing so, the techniques described herein address and overcome technical challenges confronted by conventional data sharing systems through use of decentralization to permit increased efficiency (e.g., in real time) in data sharing with increased accuracy.

A service provider system, for instance, causes a nonfungible token (NFT), as an example of a cryptographic token, to be minted to a blockchain network. The nonfungible token is a type of digital asset that represents ownership and/or proof of authenticity using blockchain technology. Each nonfungible token is configurable to store data imparting unique properties that are not interchangeable with other cryptographic tokens, and thus is nonfungible. However, it is noted that a plurality of nonfungible tokens may be minted to implement a common functionality, and as such are fungible with respect to each other. Use of fungible tokens is also contemplated (e.g., Bitcoin®, Ethereum®, etc.) and as such although the following discussion includes examples of cryptographic tokens as NFTs use of other types of fungible tokens are also contemplated.

The nonfungible token is configurable to represent a variety of types of data, such as entitlements granted by the service provider system to a holder of the token, to control access to digital content made available via one or more digital services, memorialize occurrence of an event (e.g., an entity holding the token participated at the event), membership in a group, purchase made by an entity, and so forth. NFTs, for instance, are usable to represent entitlements, ownership, and so forth such as tokens granting access to health care, insurance, or other policy holder benefits, entitlements to warranty and customer support acquired with a product purchase, tokens that serve as verifiable credentials (a university degree, license to drive), and so forth. The service provider system, for example, is configurable to generate data to initiate execution of a smart contract by a distributed state machine implemented by the blockchain network. Execution of the smart contract is then usable to cause the nonfungible token to be minted by the blockchain network.

The data generated above, for instance, is “signed” by a private key associated with a blockchain account of the service provider system to confirm authenticity of the data as part of minting the nonfungible token. Other operations may also be involved as part of minting the nonfungible token, e.g., to approve “gas.” Accordingly, the service provider system generates data representative of “what” is being represented by the nonfungible token. The data, as minted by nodes of a blockchain network, is incorporated within a block of the blockchain. As a result, the nonfungible token is recorded in an irreversible and tamper-proof manner as part of the blockchain ledger and includes the data specified by the service provider system.

Although blockchains, and more particularly blockchain ledgers, are often open for access by the public, minimal data is typically recorded as part of the blockchain to reduce cost and increase efficiency. As a result, a nonfungible token minted as part of the blockchain may be limited by an amount of data stored as part of the token, e.g., due to a cost incurred by an entity to mint the nonfungible token on the blockchain, limitations of the blockchain itself, and so forth.

Accordingly, the techniques described herein are configured to implement a decentralized metadata registry that assists data sharing between entities using the nonfungible tokens. Consider an example in which minting of a nonfungible token is initiated by a service provider system, such as to permit access to digital services of the service provider system via a network. The access, for instance, is provided as part of entitlements given by the service provider system and acquired under a smart contract, such as product rights obtained in a retail transaction, loyalty member benefits, access to digital services, representation of an active membership, used for access to a live event, confirm attendance at an event, and so forth.

The service provider system, after the minting of the nonfungible token in this example, generates registration data to register the nonfungible token in a metadata registry maintained by a metadata registry system, e.g., by a same or different service provider system. The metadata registry is configured to maintain metadata associated with an identification of the nonfungible token. The metadata is configured to include information that further describes an underlying purpose of the nonfungible token, characteristics of entities that are to receive the nonfungible token, and so forth. The metadata, for example, is configurable to describe entitlements granted to the entities that possess the nonfungible token, an ability to access digital content via a network, a discount for a product or service, participation by a respective entity in an associated event, and so forth.

Consequently, the metadata is configurable to expand beyond what is described internally by the nonfungible token on the blockchain to also describe characteristics associated with the minting of the nonfungible token, recipients of the nonfungible token, and so forth. The metadata, for instance, is usable to define characteristics of a population of entities that have received the nonfungible tokens.

The metadata registry is also configurable to incorporate search functionality to leverage use of the metadata and associated nonfungible tokens. The search functionality, for instance, is usable to search metadata to locate corresponding nonfungible tokens. As a result, the metadata is usable to describe “what” is represented by corresponding tokens, and thus is searchable to locate corresponding entities having the nonfungible tokens via a blockchain network. The search functionality, for example, is usable to locate a population of entities having nonfungible tokens based on characteristics defined by metadata associated with the nonfungible tokens in the metadata registry. As a result, the metadata registry provides a mechanism to share data that describes entity populations between service provider systems or other entities without encountering delays through use of a decentralized system as implemented using nonfungible tokens and a blockchain network. Further discussion of these and other examples is included in the following sections and shown in corresponding figures.

In the following discussion, an example blockchain environment is described as part of a digital environment that employs the metadata registry techniques described herein. Example procedures are also described that are performable in the example environment as well as other environments. Consequently, performance of the example procedures is not limited to the example environment and the example environment is not limited to performance of the example procedures.

### Decentralized Metadata Registry Environment

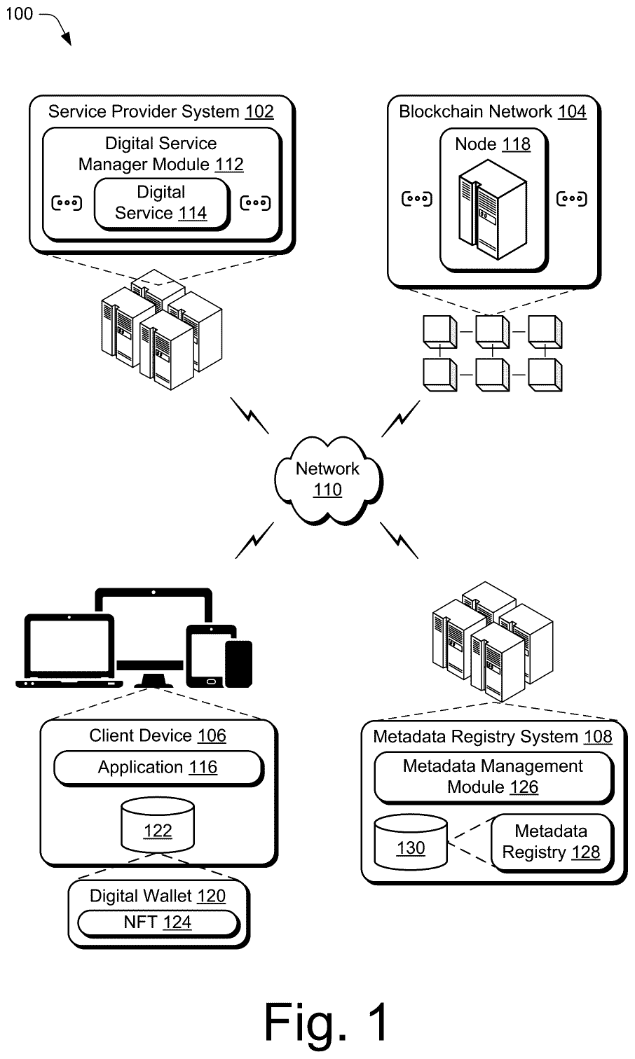

FIG. 1 is an illustration of a decentralized metadata registry environment 100 in an example implementation that is operable to employ techniques described herein. The decentralized metadata registry environment 100 includes a service provider system 102, a blockchain network 104, a plurality of client devices (an example of which is illustrated as client device 106), and a metadata registry system 108 that are communicatively coupled, one to another, via a network 110 such as the Internet.

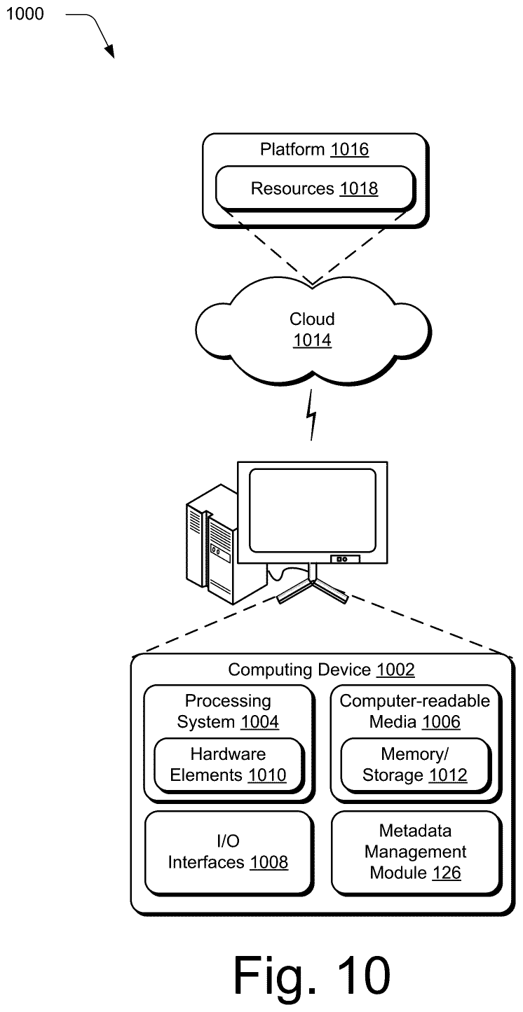

Computing devices that implement the decentralized metadata registry environment 100 are configurable in a variety of ways. A computing device, for instance, is configurable as a desktop computer, a laptop computer, a mobile device (e.g., assuming a handheld configuration such as a tablet or mobile phone), IoT device, a wearable device, AR/VR device, a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 10.

The service provider system 102 includes a digital service manager module 112 that is configured to implement at least one digital service 114. The digital service 114 is executable by the service provider system 102 (e.g., using a processing device and computer-readable storage medium) to implement functionality that is deliverable via the network 110, e.g., to the client device 106. Examples of a digital service 114 include control of access to digital content (e.g., via a streaming digital service), a social media service, software as a service, digital content creation and editing services, digital content sharing service (e.g., a stock digital content service), a generative artificial intelligence (AI) content creation service, and so forth.

The client device 106, for instance, executes an application 116 (e.g., a browser or network enabled application) having network functionality to access the digital service 114 via the network 110. The digital service 114 is executable by the service provider system 102 (e.g., via one or more servers) and/or locally through download and execution locally at the client device 106.

The blockchain network 104 is implemented by a plurality of nodes, an example of which is illustrated as node 118. Nodes are a runtime implemented using processing, memory, and network resources of respective computing devices that operate as the infrastructure of the blockchain. As part of this, the nodes 118 store, communicate, process, and manage data that makes up the blockchain. Nodes 118 are interconnected as illustrated in FIG. 1 to exchange data via the network 110, e.g., as a peer-to-peer network in a distributed and decentralized manner.

The client device 106 is illustrated as including a digital wallet 120, which is maintained in a storage device 122 at the client device 106. The digital wallet 120 is configured to store private keys associated with a user's digital address and are used to prove ownership of the assets, sign transactions, and so forth. The digital wallet 120 is associated with a blockchain address as a decentralized identifier to identify the digital wallet 120 as part of the blockchain.

The digital wallet 120 is configured to maintain a nonfungible token, an example of which is illustrated as NFT 124. As previously described, the NFT 124 is a type of digital asset, ownership of which is maintained using the blockchain network 104. The NFT 124 is usable to include a variety of data in support of a variety of functionality. As previously described, however, an amount of data that is stored as part of the NFT 124 may be limited due to a variety of factors. Further, in some instances data may involve sensitive information that is not to be shared publicly.

Accordingly, the metadata registry system 108 includes a metadata management module 126 that is configured to implement a metadata registry 128, which is illustrated as stored in a storage device 130. The metadata registry 128 is configurable to implement a shared system-of-record (i.e., a primary source of truth) for metadata that expands on functionality made available via the NFT 124. To do so, the metadata registry system 108 is configured to leverage blockchain ledgers, smart contracts, and nonfungible tokens of the blockchain network 104, operation of which is further described in the following example and shown in a corresponding figure.

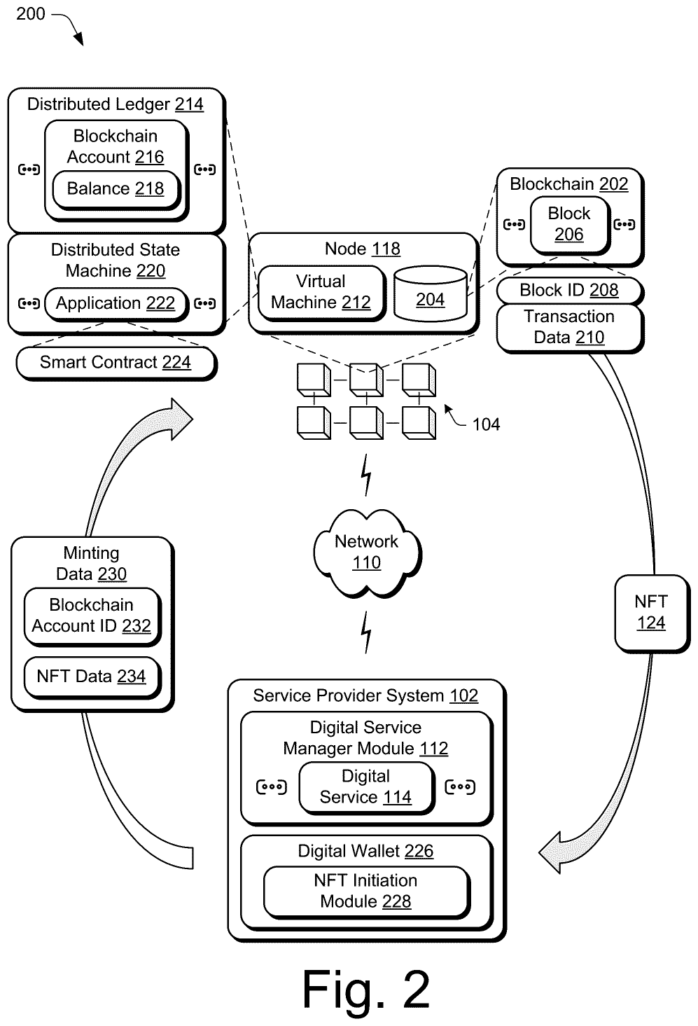

FIG. 2 is an illustration of a system 200 in an example implementation showing operation of a blockchain network 104 and a service provider system 102 of FIG. 1 in greater detail as minting a nonfungible token. The node 118 is illustrated as implementing a blockchain 202, which is maintained in a storage device 204. The blockchain 202 is formed using a plurality of blocks 206. The plurality of blocks 206 include respective block identifiers (IDs) 208 and transaction data 210. Transaction data 210 of the blocks 206 includes batches of validated transactions that are hashed and encoded. Each block 206 includes a cryptographic hash of a prior block 206 in the blockchain 202, thereby linking the blocks 206 to each other to form the blockchain 202. As a result, the blocks 206 cannot be altered retroactively without altering each subsequent block 206 in the blockchain 202 and in this way protects against attacks by malicious parties.

In order to generate the blocks 206 for addition to the blockchain 202, a node 118 is implemented as a “miner” to add a block of transactions to the blockchain 202. The other nodes of the blockchain network 104 then check if the block of transactions is valid, and based on this, determine whether to accept or reject this data. If valid, the block of transactions is stored as transaction data 210 along with a block ID 208 for a respective block 206, e.g., is stored “at the end” or “at the top” of the blockchain 202 along with a hash of a previous block in the chain. The nodes 118 then broadcast this transaction history via the network 110 for sharing with other nodes 118. This broadcast acts to synchronize the blocks 206 of the blockchain 202 across the distributed architecture of the blockchain network 104. Other types of nodes 118 are also included as part of the blockchain network 104. In one such example, full nodes are nodes that store an entirety of the blockchain 202, e.g., locally in computer-readable storage media of a respective storage device 204. Other types of nodes are also employed to implement additional functionality to govern voting events, execution of protocol operations, rules enforcement, and so forth.

The blockchain network 104 implements a virtual machine 212 that is representative of a diverse range of functionality made possible by leveraging the blockchain 202. In a first such example, the virtual machine 212 implements a distributed ledger 214 of blockchain accounts 216 and associated balances 218 of those blockchain accounts 216. Distributed ledgers 214 support secure transfer of digital assets (e.g., tokens or coins of cryptocurrencies) between blockchain accounts 216 without management by a central authority through storage as part of the transaction data 210 of the blockchain 202. Through synchronized and distributed access supported by the blockchain 202, changes to balances 218 (e.g., a number of tokens) are visible to entities having access to the blockchain 202. Techniques are also implemented to support management of the balances 218 across the blockchain accounts 216, e.g., to enforce rules that a respective blockchain account 216 does not transfer more cryptographic tokens than are available based on a balance 218 specified for that account.

In another example, the virtual machine 212 implements a distributed state machine 220 that supports application 222 execution. The distributed state machine 220 is implemented along with the transaction data 210 within the blocks 206 of the blockchain 202. By doing so, the blocks 206 describe block accounts 216 and balances 218 as described above for the distributed ledger 214.

The transaction data 210 also supports a machine state, which can change from block to block of the blockchain 202. In one example, the application 222 is executable as part of a “Turing-complete” decentralized virtual machine 212 that is distributed across the nodes 118 of the blockchain network 104. As Turing-complete, the application 222 is computationally universal to perform computing device operations, e.g., logic or computing functions. Thus, the application 222 is executable by a processing system of a computing device as software that is storable in a computer-readable storage media of the nodes 118 to perform a variety of operations.

An example of an application 222 that is executable as part of the distributed state machine 220 is a smart contract 224. A smart contract 224 is executable automatically and without user intervention (or with partial human interaction as inputs when desired) by the nodes 118 of the distributed state machine 220. Execution of the smart contract 224 includes obtaining data from a specified data source (e.g., devices, APIs, and so forth that are accessible via the network 110), and based on this data, initiating one or more operations based on conditions described in the smart contract 224. In one example, the smart contract 224 is a type of blockchain account 216 that includes a balance 218 and initiates transactions based on conditions specified by the smart contract 224, e.g., to support automated escrow and other functionalities. A variety of other examples are also contemplated that support implementation of any executable operation by a computing device using software.

Cryptocurrencies (e.g., coins of the cryptocurrency) are the native asset of the blockchain 202, and tokens are further creatable “on top” of these blockchains. In an example of a token, the smart contract 224 implements a nonfungible token, e.g., NFT 124. The NFT 124 is a digital asset that is provably unique and as such cannot be duplicated or divided. As such, the NFT 124 is not exchanged as having a same value as coins in cryptocurrency, but rather are digital assets having identifying information recorded as part of the smart contract 224. This identifying information is immutably recorded on that token's blockchain 202 and thus ownership of the token is also recorded and tracked. A variety of information is storable as part of the digital content represented by the NFT 124 as previously described.

The service provider system 102 in the illustrated example includes a digital service manager module 112 implementing a digital service 114 as previously described. The service provider system 102 also includes a digital wallet 226 having an NFT initiation module 228. The digital wallet 226 stores public and private cryptographic keys that are used to support interaction with the blockchain network 104, and more particularly respective blockchain accounts 216.

The public key supports transactions to an address of the blockchain account 216 derived from the public key, which are stored as part of the blockchain 202 to memorialize the transaction as part of transaction data 210. In one example, an address of a blockchain account 216 is generated by first generating a private key, e.g., using a randomization technique. The corresponding public key is derived from the private key and the address of the blockchain account 216 is then derived from the public key, e.g., as an entirety of the public key or as a shortened version of the public key. The private key is used to “unlock” transactions that are “locked” by the public key and gain access to the blockchain account 216, e.g., access to coins, tokens or other information maintained as part of the transaction.

In one example, a transaction is initiated between entities, e.g., client devices. Data of the transaction is encrypted using a public key. The transaction is then signed by a first client device using the private key which indicates that the transaction has not been modified, e.g., by encrypting the data being sent in the transaction using the private key. The transaction is then verifiable as authentic by using the public key included with the data. The nodes 118 use the accompanying public key to automatically verify authenticity that the transaction is signed using the private key. Transactions that fail authentication are rejected by the nodes 118. Authentic transactions are used as part of transaction data 210 in minting blocks 206 by the nodes 118 that are added to the blockchain 202, e.g., as part of the distributed ledger 214. In this way, the virtual machine 212 of the blockchain network 104 supports a variety of functionality through use of the distributed ledger 214, distributed state machine 220, and/or other blockchain and cryptographic functionality.

The system 200 also includes a service provider system 102 implementing a digital service manager module 112 and digital service 114. Digital services 114 involve electronic delivery of data and implementation of data functionality by computing devices to support a range of computing device operations. Digital services 114, for instance, include creation, management, and dissemination of digital content via the network 110, e.g., webpages, applications, digital images, digital audio, digital video, and so forth.

The service provider system 102 also includes an NFT initiation module 228. Minting of an NFT 124 is initiated by the service provider system 102 by generating minting data 230 having a blockchain account ID 232 and NFT data 234 to be included as part of the NFT 124. The NFT initiation module 228, for instance, generates the NFT data 234 that describes one or more entitlements, user characteristics, and so forth and provides this data to the blockchain network 104 for minting as an NFT 124 as part of the blockchain 202, ownership of which is associated with a blockchain account 216. The NFT 124, once minted, is configurable to support a variety of functionality, examples of which that include use in conjunction with a decentralized metadata registry are described in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### NFT Metadata Registration

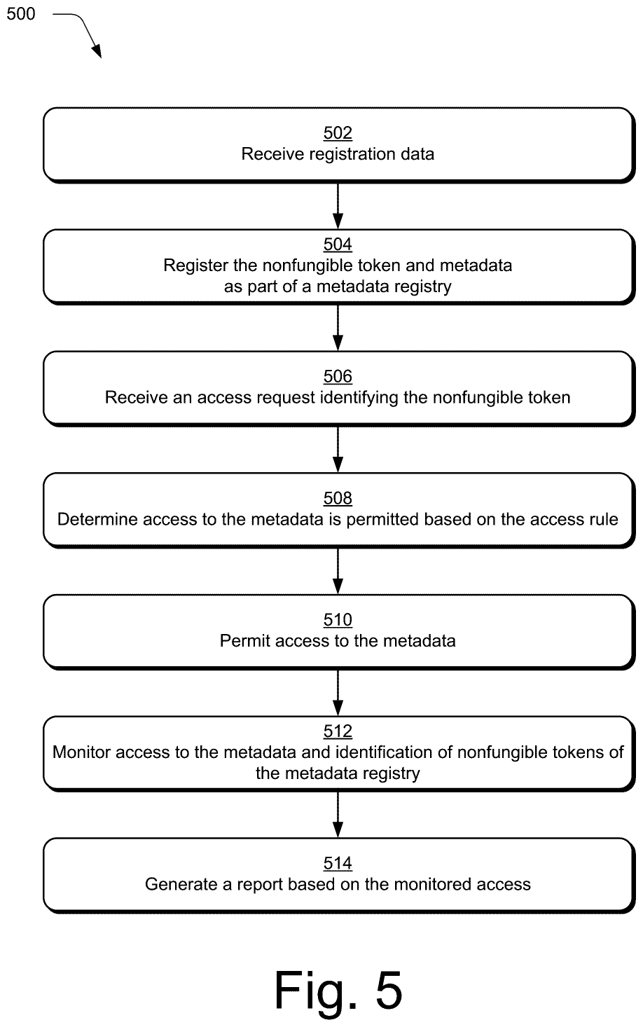

The following discussion describes decentralized metadata registry techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm. In portions of the following discussion, reference will be made in parallel with FIG. 5 that depicts a flow diagram of a procedure 500 in an example implementation of registration of a nonfungible token and metadata as part of a metadata registry and access control to the metadata based on an access rule.

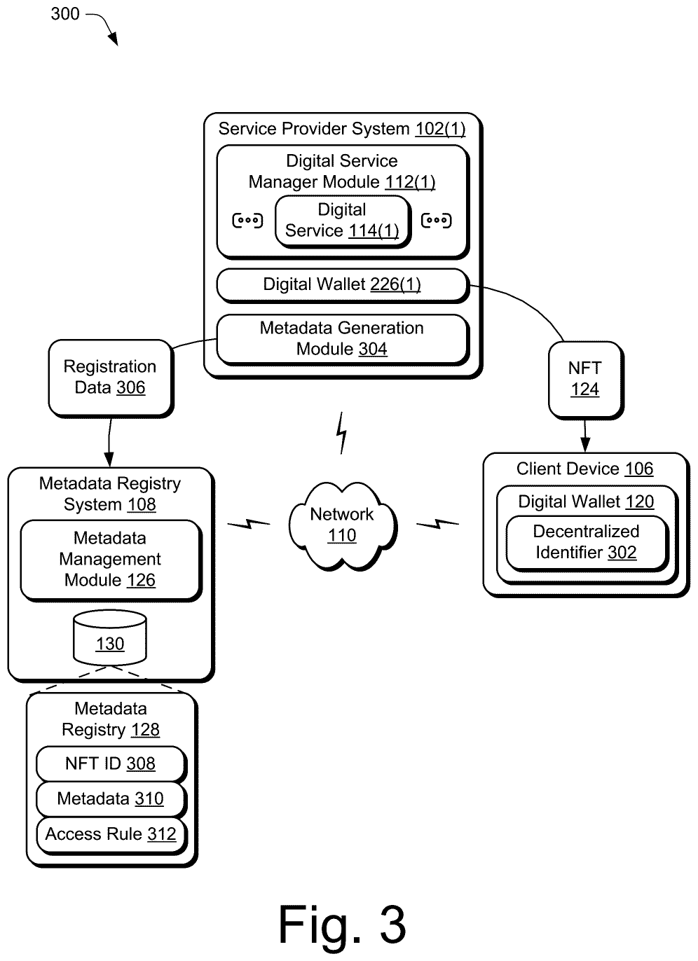

FIG. 3 depicts a system 300 in an example implementation of dissemination of a nonfungible token to a client device and registration of the nonfungible token as part of a metadata registry. The service provider system 102(1) is an example of a service provider system 102 that minted and received the NFT 124 as described in relation to FIG. 2. Accordingly, the service provider system 102(1) includes a digital service manager module 112(1) that implements a digital service 114(1). The service provider system 102(1) also includes a digital wallet 226(1) that is configured to maintain the NFT 124 received from and minted by the blockchain network 104 as previously described in relation to FIG. 2.

The NFT 124 is configurable to impart a variety of functionality in a variety of usage scenarios. The NFT 124, for instance, is configurable to describe one or more characteristics associated with entities that receive the NFT 124 (e.g., participation in an associated event), entitlements granted to the entities that possess the NFT 124 (e.g., an ability to access digital content via a network, a discount for a product or service that is verifiable via a blockchain network), and so forth.

A service provider system 120(1) initiates generation of the NFT 124 as described in relation to FIG. 2, which is then stored in a digital wallet 226(1) of the service provider system 102(1). The service provider system then transacts with a client device 106 using a smart contract 224, which results in depositing the NFT 124 in a digital wallet 120 of the client device 106, e.g., which is located using a decentralized identifier 302 associated with the digital wallet 120. The decentralized identifier 302 supports self-sovereign identity in which individuals have control the identity and corresponding personal data. The decentralized identifier 302, for instance, is configurable as a uniform resource identifier (URI) that employ a distributed ledger 214 as part of the blockchain 202 as a globally unique identifier.

The NFT 124 is configurable to represent benefits and entitlements acquired under the smart contract 224, e.g., product rights obtained in a retail transaction, loyalty member benefits, access to services and subscriptions, and so forth. Accordingly, in this example the NFT 124 is passed from the digital wallet 226(1) of the service provider system 102(1) to a digital wallet 120 of the client device 106 to provide these rights and entitlements.

The service provider system 102(1) also includes a metadata generation module 304 that is configurable to generate registration data 306 for communication to the metadata registry system 108. The registration data 306 includes an identifier of the NFT 124 (which is illustrated as NFT ID 308), metadata 310, and an access rule 312 to control access to the metadata 310.

The registration data 306, for instance, is configurable to include a smart contract ID, smart contract description, smart contract details, transaction prerequisites, consumer entitlements, and so forth. The transaction prerequisites define criteria used as a basis for acquiring the NFT 124 under the smart contract 224, e.g., fee amount, linked or related tokens, contract terms, terms summary, and so forth. The consumer entitlements describe rights and benefits granted under the smart contract 224 using the NFT 124.

The metadata 310 is configured to supplement an explanation of the NFT 124 as a way to “unlock” an underlying meaning of transactions and entitlements recorded by the NFT 124 on the blockchain 202. The metadata 310, for instance, is configurable to indicate an active membership in a loyalty program, grant access to an event (e.g., sporting event or concert), confirm presence at an event, and so forth. The metadata 310 may also include potentially sensitive information that is not desired to be shared publicly as part of the NFT 124.

Accordingly, the metadata registry system 108 receives the registration data 306 from the service provider system 102(1) (block 502). The NFT 124 and the metadata 310 are then registered as part of the metadata registry 128 (block 504). The metadata management module 126, for instance, forms an entry in the metadata registry 128 that associates an NFT ID 308 corresponding to the NFT 124 with the metadata 310. The metadata 310 as described above provides a description (e.g., via text, digital images, or other techniques) as a supplement to the NFT 124.

The access rule 312 is set by the service provider system 102(1) to control access provided by the metadata registry system 108 to the metadata 310. In this way, the service provider system 102(1) is given a degree of control as to “how” and “when” the metadata 310 is accessed as well as “who” is to be given that access as part of sharing the metadata 310. Consequently, the service provider system 102(1) is given control of a specific set of audience data that may be shared with third parties, which can include blockchain transactions as well as other sources of audience data.

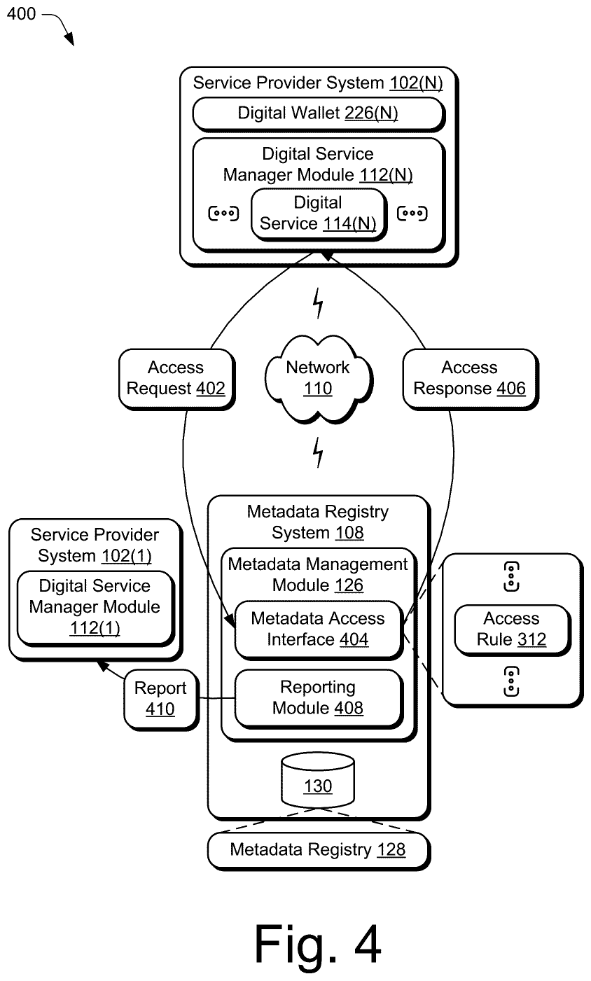

FIG. 4 depicts a system 400 in an example implementation of access to metadata associated with a nonfungible token as part of a metadata registry. Continuing with the previous example, another service provider system 102(N) is illustrated having a digital wallet 226(N) and a digital service manager module 112(N) implementing a digital service 114(N). The service provider system 102(N), for instance, wishes to identify a particular population of entities based on nonfungible tokens received by those entities.

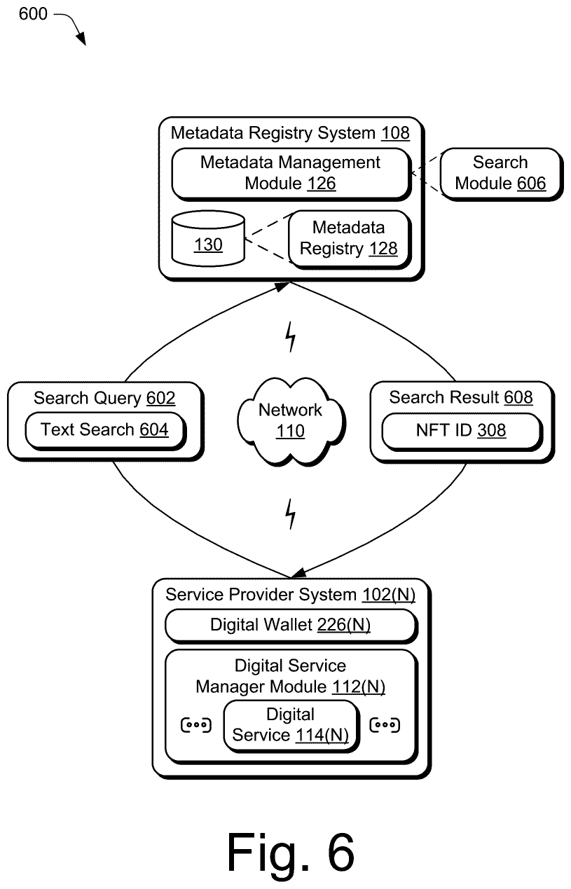

Accordingly, an access request 402 is received at a metadata access interface 404 of the metadata management module 126. The access request 402 includes an identifier of an NFT 124 (block 506), e.g., includes the NFT ID 308. A determination is then made by the metadata access interface 404 that access to the metadata is permitted based on an access rule 312 (block 508). The access rule 312, for instance, is configurable to identify a particular entity that is permitted access (e.g., using a decentralized identifier), characteristics of entities that are permitted access (e.g., group membership, demographics), and so forth. Accordingly, an access response 406 is generated that is communicated back to the service provider system 102(N) via the network 110 indicating that access to the metadata is permitted (block 510), e.g., to an originating device of the access request 402. Access to the metadata 310 is usable to support a variety of functionality, further discussion of which is included with respect to FIGS. 6-9 in the following description.

The metadata management module 126 also includes a reporting module 408 that is configured to generate a report 410 describing access and access attempts made to the metadata 310. The report 410 in the illustrated example is transmitted to a source of the metadata, e.g., the service provider system 102(1) of FIG. 1.

The reporting module 408, for instance, monitors access to the metadata 310 and identification of nonfungible tokens of the metadata registry 128 (block 512). The report 410 is then generated based on the monitored access (block 514), e.g., to describe which entities have requested access, have been permitted or denied access, which items of metadata 310 have been accessed, and so on. In this way, the service provider system 102(1) that originated the metadata 310 is provided insight into how the metadata 310 is accessed via the metadata registry system 108. The metadata 310 and corresponding metadata registry 128 are usable to support a variety of functionalities, examples of which are described in the following section and shown using corresponding figures.

### NFT Metadata Search and Output

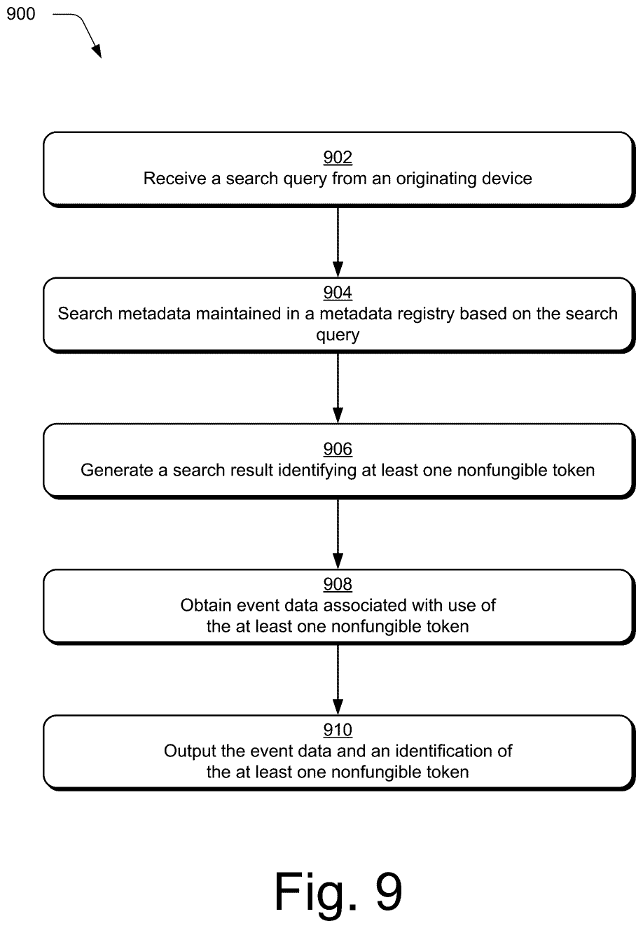

The following discussion describes decentralized metadata registry techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm. In portions of the following discussion, reference will be made in parallel with FIG. 9 that depicts a flow diagram of a procedure 900 in an example implementation of a search performed using metadata in a metadata registry to locate a nonfungible token and event data corresponding to the nonfungible token.

FIG. 6 depicts a system 600 in an example implementation in which an access request to a metadata registry is configured as a search query to search metadata to locate a corresponding nonfungible token. The service provider system 102(N), for instance, generates a search query 602 to search metadata maintained in the metadata registry 128 by the metadata registry system 108. The search query 602, for instance, is configurable as a text search 604 to perform a keyword search to locate corresponding metadata included in the metadata registry. As previously described, a wide range of data may be stored as part of the metadata 310 in the metadata registry 128. Accordingly, the text search 604 may also be configured in a variety of ways to locate this data, e.g., describing characteristics of entitlements, of recipients of the NFT 124, demographics, and so forth.

Accordingly, the metadata registry system 108 receives the search query 602 from an originating device (block 902), e.g., the service provider system 102(N). A search module 606 is then employed by the metadata management module 126 to search metadata 310 maintained in the metadata registry 128 based on the search query 602 (block 904), e.g., as a keyword search, image search, use of natural language processing as part of machine learning implemented by a machine-learning model, and so forth. The search module 606 then generates a search result 608 that identifies an NFT corresponding to metadata found during the search (block 906), e.g., the NFT ID 308.

The search query 602, for instance, may include text specifying “loyalty program members for Brand X.” The search result 608 may therefore include NFT IDs of NFTs that are provided by Brand X to the loyalty program members. In this way, the search module 606 supports techniques to engineer user populations, e.g., in support of digital marketing and other techniques. The NFT ID 308 is then usable to obtain event data associated with use of the at least one nonfungible token (block 908) and output the event data and an identification of the at least one nonfungible token (block 910), examples of which are described in further detail in the following discussion.

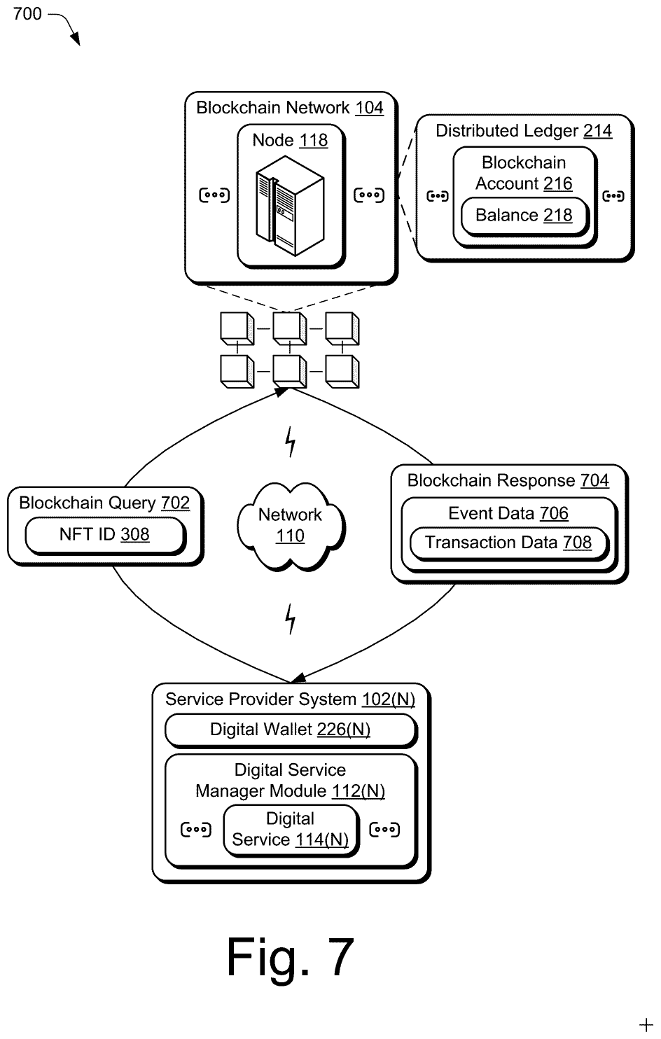

FIG. 7 depicts a system 700 in an example implementation in which event data is located based on a nonfungible token identifier received as part of a search result of FIG. 6. In this example, the NFT ID 308 is included as part of a blockchain query 702, e.g., generated as part of a blockchain explorer.

A blockchain response 704 is therefore generated directly by the blockchain network 104 based on a search of the distributed ledger 214 using the blockchain query 702. The blockchain response 704 includes event data 706 describing use of the NFT 124 for receipt by the service provider system 102(N), i.e., the originating device of the blockchain query 702. The blockchain response 704 is configurable to include transaction data 708 describing blockchain transactions performed and memorialized by the distributed ledger 214. In this way, the service provider system 102(N) may obtain event data 706 directly, thereby improving efficiency in data sharing implementation. The metadata registry system 108 may also support functionality to output event data as described in the following example.

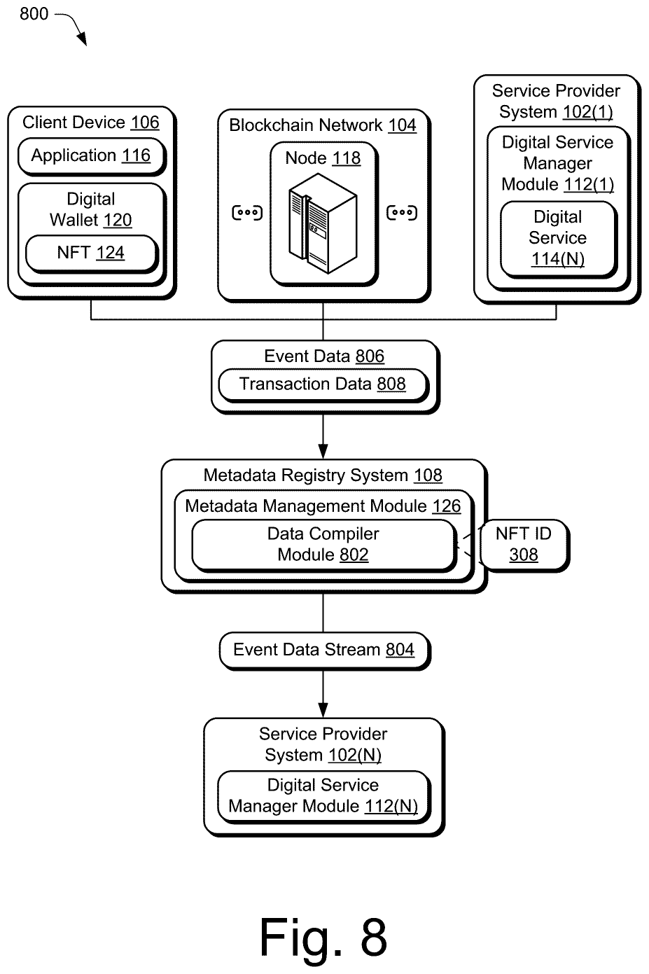

FIG. 8 depicts a system 800 in an example implementation in which event data is located by a metadata registry system based on a nonfungible token identifier received as part of a search result of FIG. 6. Continuing with the example of FIG. 6, the service provider system 102(N) generated a search query 602 which is usable to locate an NFT ID 308 based on a search of NFT ID 308. The NFT ID 308 in this example is then usable by a data compiler module 802 to generate an event data stream 804 based on event data 806 collected by the metadata registry system 108 itself.

The data compiler module 802, for instance, may interact with the client device 106, blockchain network 104 (e.g., to receive transaction data 808), service provider system 102(1), and/or other entities to obtain event data 806 corresponding to the NFT ID 308. The event data 806 is then used to generate an event data stream 804 in this example, e.g., which may be performed in real time as the event data is generated. The service provider system 102(N), for instance, may “subscribe” to the event data stream 804 via the metadata registry system 108 as a digital service. A variety of other examples are also contemplated.

In this way, a variety of data sharing protocols are supported as described in the examples of FIGS. 7 and 8. The data sharing protocols, for instance, support on demand push/pull of metadata, solely (e.g., entities perform their own blockchain queries as shown in FIG. 7), on demand push/pull of historical events combining transaction and metadata, on demand push/pull of designated entity groupings, real-time stream of blockchain transactions and metadata as shown in FIG. 8, and so forth. In this way, the metadata registry system 108 as described above supports control over which metadata is shared by the metadata registry system 108, which entities are permitted to access the metadata 310 via the metadata registry system 108, and may also control how the data is transferred, e.g., from a selection of one or a plurality of transmission protocols.

### Example System and Device

FIG. 10 illustrates an example system generally at 1000 that includes an example computing device 1002 that is representative of one or more computing systems and/or devices that implement the various techniques described herein. This is illustrated through inclusion of a metadata management module 126. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a search query via a network from an originating device;
searching, by the processing device, metadata maintained in a metadata registry based on the search query, the metadata describing one or more characteristics associated with a plurality of nonfungible tokens, respectively;
generating, by the processing device, a search result identifying at least one nonfungible token of a plurality of nonfungible tokens based on the searching;
obtaining, by the processing device, event data associated with use of the at least one nonfungible token; and
outputting by the processing device, the event data and an identification of the at least one nonfungible token for receipt by the originating device.

2. The method as described in claim 1, wherein the nonfungible token is generated through execution of a smart contract by a distributed state machine of a blockchain network.

3. The method as described in claim 1, wherein the outputting of the event data is performed as an event data stream in real time.

4. The method as described in claim 1, wherein the at least one nonfungible token is configured to permit access to digital content by an entity that possesses the at least one nonfungible token.

5. The method as described in claim 1, wherein the event data describes a purchase made by an entity having the at least one nonfungible token.

6. The method as described in claim 1, wherein the event data describes demographics associated an entity that possesses the at least one nonfungible token.

7. The method as described in claim 1, wherein the obtaining includes identifying one or more entities that possess the at least one nonfungible token by querying a blockchain network.

8. The method as described in claim 1, wherein the event data includes transaction data associated with use of the at least one nonfungible token as part of a blockchain network.

9. A computing device comprising:
a processing device; and
a computer-readable storage medium storing instructions that responsive to execution by the processing device causes the processing device to perform operations including:
receiving registration data from an originating device, the registration data identifying:
a cryptographic token;
metadata describing one or more characteristics associated with entities that receive the cryptographic token; and
access rules to control access to the metadata;
registering the nonfungible token, the metadata, and the access rules as part of a metadata registry;
receiving an access request from an originating device, the access request identifying the cryptographic token and requesting access to metadata associated with the cryptographic token;
determining that access to the metadata is permitted based on the access rule; and
permitting access to the metadata by the originating device responsive to the determining.

10. The computing device as described in claim 9, wherein the one or more characteristics include entitlements granted to the entities that possess the cryptographic token.

11. The computing device as described in claim 10, wherein the entitlements include an ability to access digital content via a network.

12. The computing device as described in claim 10, wherein the entitlements include a discount for a product or service that is verifiable via a blockchain network.

13. The computing device as described in claim 9, wherein the one or more characteristics indicate participation by a respective entity in an associated event.

14. The computing device as described in claim 9, wherein the cryptographic token is a nonfungible token generated through execution of a smart contract by a distributed state machine of a blockchain network.

15. A method comprising:
receiving, by a processing device, registration data via a network from an originating device, the registration data identifying:
nonfungible tokens (NFT); and
metadata describing one or more characteristics associated with entities that receive the nonfungible tokens, respectively;
registering, by the processing device, the nonfungible tokens and the metadata in a metadata registry;
monitoring, by the processing device, access to the metadata and identification of the nonfungible tokens from the metadata registry provided to a plurality of service provider systems; and
generating, by the processing device, a report for communication via the network to the originating device, the report based on the monitored access.

16. The method as described in claim 15, wherein the report identifies the plurality of service provider systems that accessed the metadata.

17. The method as described in claim 15, wherein the report identifies the metadata accessed by the plurality of service provider systems.

18. The method as described in claim 15, wherein the report identifies entities that possess the nonfungible tokens.

19. The method as described in claim 18, wherein the generating includes identifying transactions specified by a blockchain network that identifies the entities that possess the nonfungible tokens.

20. The method as described in claim 15, wherein the nonfungible tokens are generated through execution of smart contracts by distributed state machines of a blockchain network.
